(19) United States
(12) Patent Application Publication
(10) Pub. No.: US 2007/0087846 A1
(43) Pub. Date: Apr. 19, 2007

(54) UNIVERSAL JOINT WITH VIBRATION ISOLATION

(75) Inventors: Steven R. Nelson, Canton, CT (US); Scott A. Filion, Cheshire, CT (US)

Correspondence Address: MICHAEL BEST & FRIEDRICH, LLP, 100 E WISCONSIN AVENUE, Suite 3300, MILWAUKEE, WI, 53202, US

(73) Assignee: Timken US Corporation, Torrington, CT (US)

(21) Appl. No.: 11/538,846

(22) Filed: Oct. 5, 2006

Related U.S. Application Data
(60) Provisional application No. 60/724,737, filed on Oct. 7, 2005.

(51) Int. Cl. F16D 3/28

(52) U.S. Cl. 464/70

(57) ABSTRACT

A joint operable to couple a first shaft to a second shaft includes a first yoke coupled to the first shalt and defining a first aperture. A second yoke is coupled to the second shaft and defines a second aperture. A first bearing is coupled to the first yoke and is at least partially disposed within the first aperture. A second bearing is coupled to the second yoke and is at least partially disposed within the second aperture. A cross member has a first boss coupled to the first bearing and a second boss coupled to the second bearing. A first resilient member is positioned between the first bearing and the first boss to interconnect the first boss and the first yoke, and a second resilient member is positioned between the second bearing and the second boss to interconnect the second boss and the second yoke.

### CROSS REFERENCE TO RELATED APPLICATIONS

This application claims priority under 35 U.S.C. §119 to provisional patent application No. 60/724,737, filed on Oct. 7, 2005, which is hereby fully incorporated by reference.

### BACKGROUND

The present invention relates to a universal joint (U-joint). More particularly, the invention relates to a U-joint that includes vibration isolation.

Universal joints, commonly referred to as U-joints are often used to connect two rotating shafts that are not aligned on a common axis. The U-joint allows each shaft to rotate about its axis without excessive friction or variation in rotational forces throughout the rotation.

Applications that commonly employ a U-joint include rack-and-pinion and recirculating-ball steering systems, including direct (manual) and hydraulic and electric power steering. Many automobiles employ steering systems that includes one or more U-joints. In automobile applications, the design of the steering system and the U-joint can affect the overall noise, vibration, and handling of the vehicle.

At present, steering systems generally employ a flexible disk coupling or a bushing style isolator that partially isolates the front wheels from the steering wheel. Thus, many of the vibrations and forces applied to the front wheels of the vehicle or generated by the power steering system are not transferred through the steering wheel to the driver's hands. However, the amount of isolation provided can adversely affect the handling of the vehicle. As such, the design of the system should account for vibration, noise, and handling.

### SUMMARY

The present invention provides a U-joint that includes a first yoke and a second yoke interconnected by a cross member. The cross member includes four trunions with a trunion end coupled to each trunion. Each trunion end includes a resilient member coupled to a trunion boss, an inner cap covering the resilient member, and an outer cup. A bearing is disposed between the inner cap and the outer cup such that the trunion is rotatable relative to the yoke.

In one embodiment, the invention provides a joint operable to couple a first shaft to a second shaft. The joint includes a first yoke coupled to the first shaft and defining a first aperture, a second yoke coupled to the second shaft and defining a second aperture, and a first bearing coupled to the first yoke and at least partially disposed within the first aperture. A second bearing is coupled to the second yoke and is at least partially disposed within the second aperture. A cross member has a first boss coupled to the first bearing and a second boss coupled to the second bearing. A first resilient member is positioned between the first bearing and the first boss to interconnect the first boss and the first yoke, and a second resilient member is positioned between the second bearing and the second boss to interconnect the second boss and the second yoke.

In another embodiment, the invention provides a joint operable to couple a first shaft to a second shaft. The joint includes a first yoke coupled to the first shaft, a second yoke coupled to the second shaft, and a cross member that includes a first trunion and a second trunion. The second trunion is engageable with the second yoke. A first resilient member has an inner surface sized to closely fit the first trunion and an outer surface. A first inner cap has an inner cap surface sized to closely fit the outer surface of the first resilient member and a cap outer surface engageable with the first yoke.

In another embodiment, the invention provides a joint that is operable to couple a first shaft to a second shaft. The joint includes a first yoke coupled to the first shaft, a second yoke coupled to the second shaft, and a cross member that includes a first trunion and a second trunion. The second trunion is engageable with the second yoke. A first resilient member at least partially covers the first trunion and a first inner cap at least partially covers the first resilient member. A first outer cup at least partially covers the first inner cap and is engageable with the first yoke. A first leg is formed as part of and extends from the first resilient member. The leg is positioned such that a portion of the leg is disposed outside of the first outer cup.

### BRIEF DESCRIPTION OF THE DRAWINGS

FIG. 1 is a perspective view of a portion of a rack and pinion steering system including a U-joint;

FIG. 2 is an exploded view of the U-joint of FIG. 1;

FIG. 3 is a schematic section view of the U-joint of FIG. 1 taken along line 3-3 of FIG. 2; and

FIG. 4 is an enlarged view of a trunion end of the U-joint of FIG. 1;

FIG. 5 is an enlarged view of a portion of the trunion end of FIG. 4; and

FIG. 6 is an enlarged view of a portion of another trunion including a lip seal.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

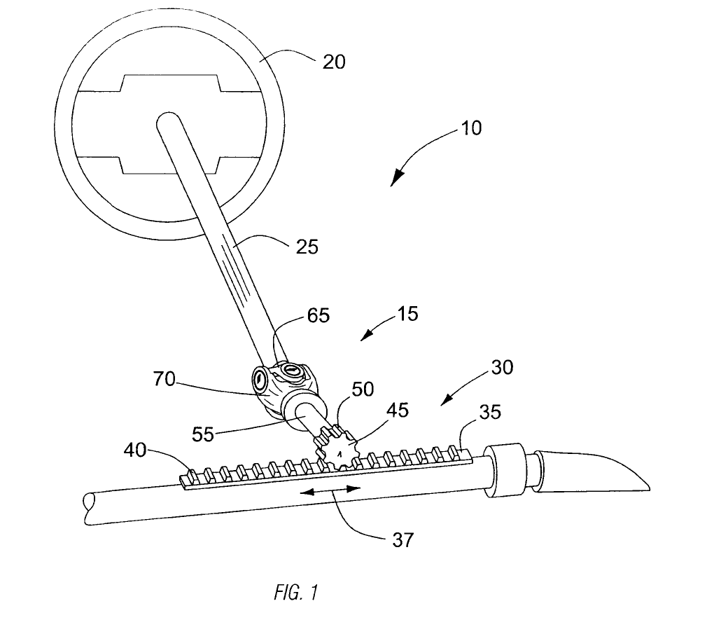

FIG. 1 illustrates a portion of one possible steering mechanism 10 that includes a U-joint 15 and is suited for use in converting rotary motion to linear motion. In a typical application, the linear motion is used to turn a pair of turnable wheels on a vehicle such as an automobile. The steering system 10 includes a steering wheel 20 that is coupled to a steering shaft 25 such that rotation of the steering wheel 20 produces a corresponding rotation of the steering shaft 25. The steering shaft 25 generally extends downwardly and forwardly from the steering wheel 20.

The steering mechanism 10 also includes a rack-and-pinion arrangement 30. A rack 35 extends between the turnable wheels of the vehicle and moves along a substantially linear path 37 in response to rotation of the steering wheel 20. The rack 35 includes a plurality of teeth 40 that extend outwardly from a substantially planar surface. The teeth 40 are spaced apart from one another to define a plurality of channels that extend in a direction that is substantially normal to the direction of movement 37 of the rack 35. Of course other rack designs may employ differently arranged teeth as may be desired for the particular application.

A pinion 45 includes a plurality of teeth 50 that are sized and pitched to substantially match the teeth 40 of the rack 35. A pinion shaft 55 supports the pinion 45 in an engaged position such that rotation of the pinion 45 produces a corresponding linear movement of the rack 35. In most applications, the pinion shaft 55 resides in substantially the same plane as the rack 35 and is oriented such that the pinion shaft 55 is normal to the direction of movement 37 of the rack 35. With this arrangement, the pinion shaft 55 is not parallel to the steering shaft 25. As such, the U-joint 15 interconnects the steering shaft 25 and the pinion shaft 55 such that rotation of the steering shaft 25 produces a corresponding rotation of the pinion shaft 55 and the pinion 45 to produce the desired linear movement of the rack 35 to turn the wheels of the vehicle.

It should be noted that many other steering systems that employ one or more U-joints 15 are possible. As such, the invention should no be limited to steering systems similar to the simple rack-and-pinion system 10 illustrated herein. For example, steering systems may employ multiple shafts with multiple U-joints that allow the shaft to move around multiple objects that impede the straight path. In addition, many steering systems are far more complex than the one illustrated. For example, a hydraulic steering system includes a valve that is moved by the shaft to actuate the power steering mechanism and turn the vehicle. Furthermore, U-joints 15 can also be used in applications other than steering systems. For example, an automobile drive shaft o ten includes one or more U-joints and may be a suitable application for the invention. As such, the invention should not be limited to steering system applications alone.

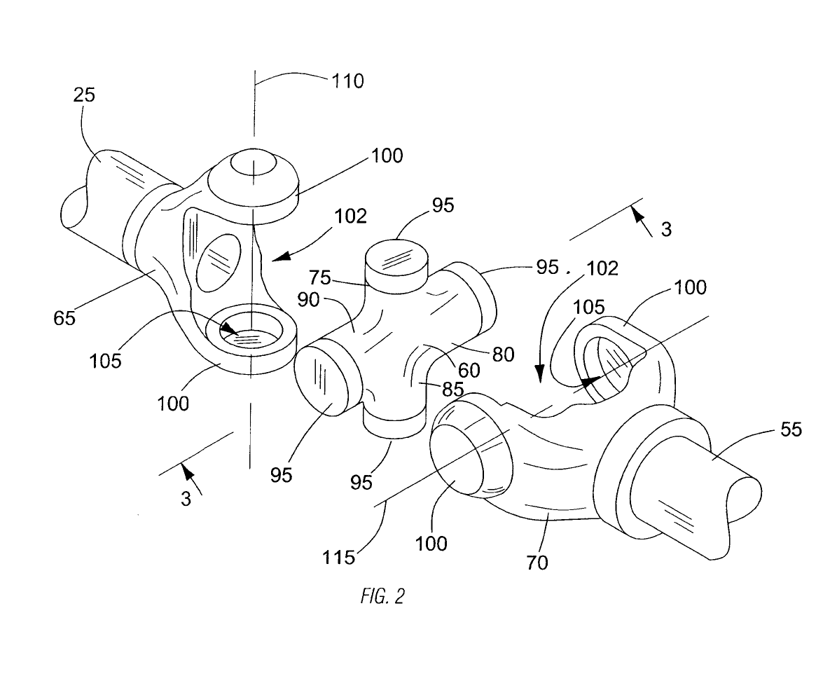

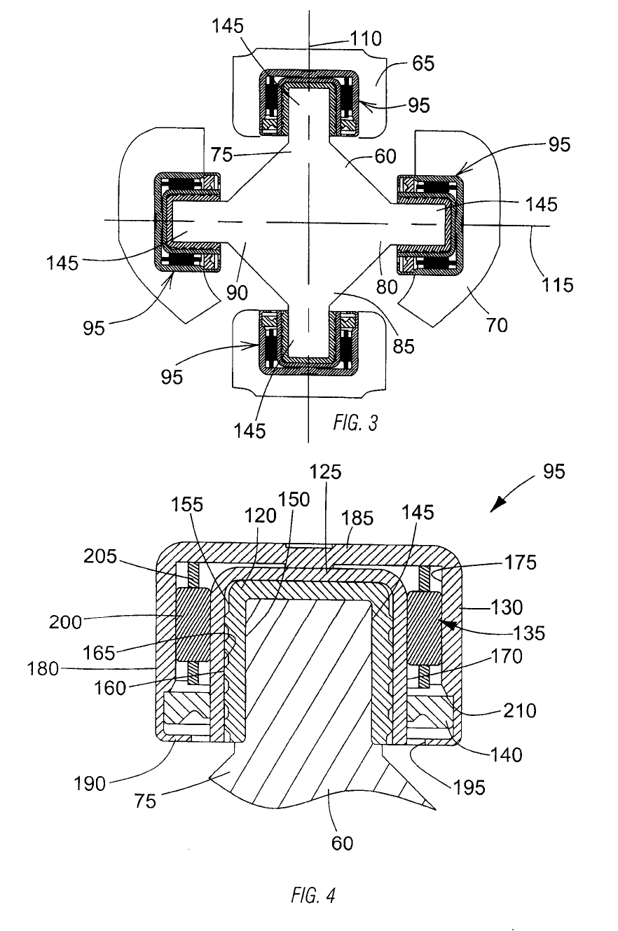

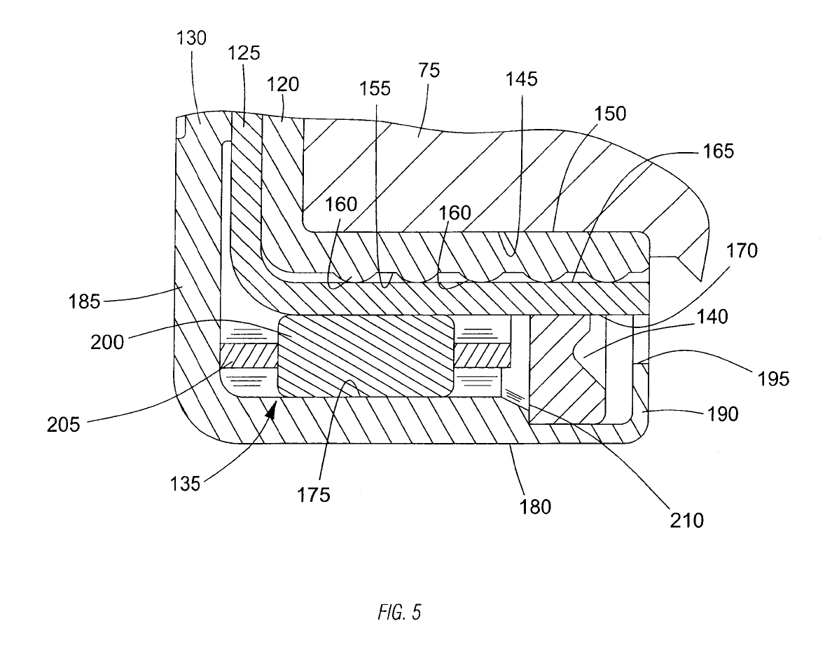

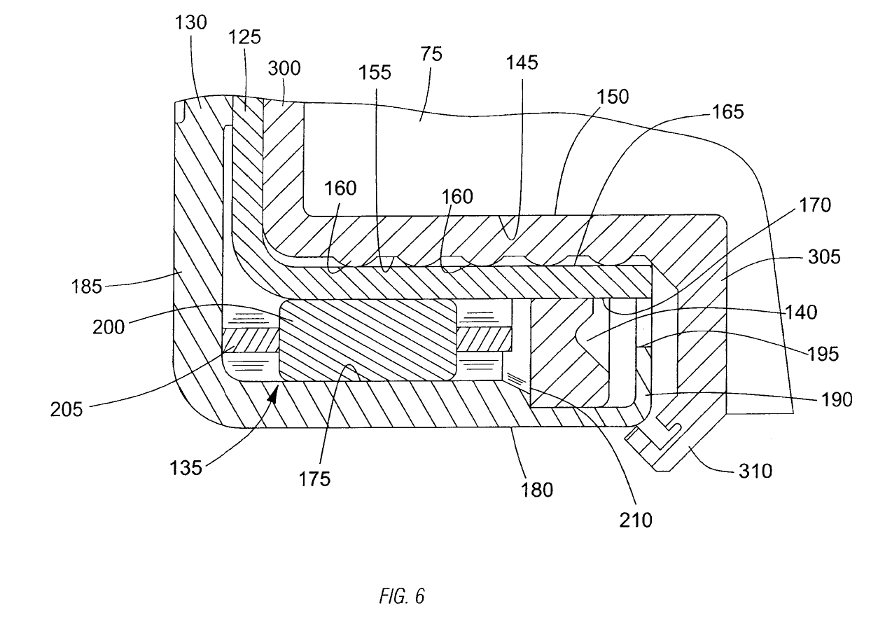

The U-joint 15, illustrated in FIGS. 2 and 3 includes a cross member 60, a first yoke 65, and a second yoke 70. The cross member 60 includes four trunions that are equally spaced around an axis. As illustrated in FIGS. 2 and 3, a first trunion 75 is at the twelve o'clock position, a second trunion 80 is at the three o'clock position, a third trunion 85 is at the six o'clock position, and a fourth trunion 90 is at the nine o'clock position. However, these orientations are given for discussion purposes only, as the invention is not limited to these orientations. Trunion ends 95 are coupled to, or formed as part of, each trunion 75, 80, 85, 90 as will be described in greater detail with regard to FIGS. 4 and 5.

Each yoke 65, 70 attaches to, or is formed as part of, one of the steering shaft 25 and the pinion shaft 55 and includes two ears 100 that extend along the axis of the respective shaft 25, 55. Of course, the yokes 65, 70 could alternatively be formed on or attached to other shafts in the steering linkage. The two ears 100 of each yoke 65, 70 are spaced apart from one another to define a substantially U-shaped space 102. Ear apertures 105 are formed in each of the yoke ears 100 to receive the trunions ends 95. As illustrated in FIG. 2, the ear apertures 105 of the first yoke 65 are formed along a first axis 110 and receive the ends of the first trunion 75 and the third trunion 85, while the ear apertures 105 of the second yoke 70 are formed along a second axis 115, generally perpendicular to the first axis 110, and receive the ends of the second trunion 80 and the fourth trunion 90. In some constructions, the ear apertures 105 are blind holes as illustrated in FIG. 2, while other constructions may employ through holes. The actual arrangement of the ear apertures 105 is not critical to the function of the invention so long as they are properly sized to receive the trunion ends 95.

Turning to FIGS. 4 and 5, one of the trunion ends 95 is shown in greater detail. The trunion end 95 includes a resilient member 120, an inner cap 125, and a bearing 135 that includes an outer cup 130 and a seal 140. Each trunion defines a substantially cylindrical boss 145 that receives the resilient member 120. As shown in FIG. 4, the resilient member 120 is substantially cup-shaped with an inner surface 150 that closely fits the surface of the boss 145. The resilient member 120 includes a substantially cylindrical outer surface 155 on which are disposed several ribs 160. Each rib 160 extends around the circumference of the resilient member 120 and is substantially semi-circular in cross section, with other cross sections also being possible. In the illustrated construction, five ribs 160 are employed with more or fewer ribs 160 also being possible. In other constructions, ribs are positioned on the inner surface 150 rather than the outer surface 155.

The resilient member 120 can be formed using a resilient or elastomeric material such as urethane, with other materials also being suitable for use (e.g., polyurethane, plastic, natural rubber, nitrile, silicone, synthetic rubber, cork, and the like). Thus, various resilient members made of various materials having different properties are possible. For example, soft rubber may be employed where high resilience is required, while hard plastic or another less resilient material may be employed in applications that require less resilience. As one of ordinary skill will realize, many different materials may be suited for use in manufacturing resilient members 120. As such, the invention should not be limited to the materials listed herein.

The inner cap 125 is also substantially cup-shaped and defines an inner cylindrical surface 165 and an inner race surface 170. The inner cylindrical surface 165 is sized to closely fit over the ribs 160 of the resilient member 120. In the illustrated construction, a small press fit or interference fit is established between the inner cap 125 and the ribs 160. The ribs 160 reduce the total surface area that must be compressed during the installation of the inner cap 125. Thus, the ribs 160 serve to increase the effective resilience of the resilient member 120 as it is compressed, thereby making it easier to install the inner cap 125 over the resilient member 120. However, as the amount of compression increases, a greater amount of surface area must be compressed, thus reducing the effective resilience of the resilient member 120. As such, the shape, size, quantity, and arrangement of the ribs 160 can be varied to vary the effective resilience of the resilient member 120. The inner race surface 170 is substantially smooth and defines an inner race for the bearing 135 as discussed below. In the illustrated construction, the inner cap 125 is manufactured from a steel material (e.g., carbon steel, stainless steel, etc.). However, other materials may also be suitable for use in manufacturing the inner cap 125 (e.g., brass, bronze, iron, ceramic, composite, plastic, etc.).

The outer cup 130 includes a cylindrical wall that defines an outer race 175 and an outer cylindrical surface 180. The outer race 175 is a substantially smooth cylindrical surface that defines the innermost surface of the outer cup 130 and serves as the outer race for the bearing 135. The outer cylindrical surface 180 is sized to fit within the ear aperture 105 of one of the yoke ears 100. In the illustrated construction, an interference or press fit is established between the ear aperture 105 and the outer cylindrical surface 180 such that no additional components are needed to hold the outer cylindrical surface 180 within the ear aperture 105. However, in some applications is may be desired to provide for serviceability of the bearings and cross member. In these constructions, a looser fit is employed with a locking member (e.g., snap rings, and the like) retaining the outer cup in the desired position.

The outer cup 130 also includes two walls that are substantially normal to the outer cylindrical surface 180. A first wall 185 spans the entire area defined by the outer cylindrical surface 180 and defines an end. In constructions in which the ear apertures 105 are blind holes, the end provides a positive stop when the trunion end 95 or outer cup 130 is inserted into the ear aperture 105. A second wall 190 extends only partially across the opposite end surface, and as such defines a boss aperture 195 sized to allow for the passage of the boss 145, resilient member 120, and inner cap 125.

With reference to FIG. 5, the bearing 135 includes several needles 200 or rolling elements supported by a cage 205 such that the needles 200 engage the outer race 175 and the inner race surface 170 to allow the inner cap 125 to rotate with respect to the outer cup 130 about the ear aperture axis 110 or 115 with little resistance. As is well known in the art, the needles 200 of the bearing 135 are supported by a cage 205 in a manner that maintains their spacing and allows them to rotate around axes that are substantially parallel to the ear aperture axis 110 or 115. The outer race surface 175, the inner race surface 170, and the needles 200 are sized to provide a tight fit between the three components when assembled. The tight fit reduces unwanted play between the components and aids in maintaining the position of the needles 299 within the outer cup 130.

Before proceeding, it should be noted that while a bearing 135 is shown and described, other types of bearings are also suitable for use. For example, other constructions may employ needle bearings with a full complement of needles (no cage) or other bearings or roller elements such as, but not limited to roller bearings, ball bearings, taper bearings, journal bearings or the like, rather than needle bearings. As such, the invention should not be limited to needle bearings alone.

The seal 140 is an annular resilient member that fits between the outer cup 130 and the inner cap 125 and inhibits movement of matter between the bearing 135 and the exterior of the outer cup 130. As illustrated in FIG. 5, the outer cup includes a lip or shoulder 210 that supports the seal 140 between the bearing 135 and the boss aperture 195. In most constructions, the space occupied by the bearing 135 is also filled with a lubricant, such as grease. The seal 140 inhibits the loss of the grease and also reduces the likelihood of dirt, rocks, pebbles, chips, or other debris entering the grease. In preferred constructions, the seal 140 is larger than the space into which it fits such that it is slightly compressed during assembly. In addition, the use of a press fit between the outer cup 130 and the ear aperture 105 further compresses the seal 140 as the outer Cup 130 displaces during installation. The compression of the seal 140 serves to maintain the position of the seal 140 within the outer cup 130 and enhances the performance of the seal 140.

To assemble each trunion end 95, the resilient member 120 is placed over the boss 145 In some constructions one of, or both of, the boss 145 and the inner surface 150 of the resilient member 120 may be roughened or contoured to improve the engagement between the boss 145 and the resilient member 120. Furthermore, some constructions may employ an adhesive to further enhance the bond between the resilient member 120 and the boss 145. The inner cap 125 is then positioned on top of the resilient member 120. As discussed, a slight interference lit between the resilient member 120 and the inner cap 125 is desirable. Thus, the friction between the two components is generally sufficient to maintain the position of the inner cap 125. However, in some constructions, an adhesive may be used to enhance the connection between the resilient member 120 and the inner cap 125. The needles 200 and cage 205 are positioned within the outer cup 130 such that the cage 205 contacts the first wall 185. The seal 140 is then positioned within the outer cup 130 such that it engages the lip 210. In this position, the seal 140 is between the needles 200 and the boss aperture 195.

The outer cup 130, including the needles 200 and the seal 140, is then coupled to the trunion end 95, including the resilient member 120 and the inner cap 125. The spacing between the inner cap 125 and the outer cup 130 is such that the bearing 135 pushes the inner cap 125 radially and axially inward (toward the center of the boss 145), further compressing the resilient member 120. Thus, the bearing 135 is held firmly in place with little or no unwanted play, and the resilient member 120 is compressively preloaded. In addition, the sizing is such that less restrictive tolerances can be employed during the manufacture of the resilient member 120, the inner cap 125, the needles 200, and the outer cup 130 as any tolerance stackups are accommodated by the resilient member 120. Once the trunion ends 95 are assembled onto the cross member 60, the cross member 60 and yokes 65, 70 can be assembled into the completed U-joint 15 as is known in the art. In applications with through hole ear apertures, the resilient member 120 and inner cap 125 are first assembled onto the cross member 60. The cross member is then positioned within the ear aperture, and the bearing 135 is installed or pressed into the ear aperture such that it also engages the outer cup 125.

With reference to FIG. 1, the operation of the illustrated steering mechanism 10 employing the U-joint 15 of the invention will be described. As the vehicle passes over a road, the wheels pass over bumps that produce vibrations. The vibrations pass from the wheels to the rack 35 and from the rack 35, to the pinion 45. From the pinion, the vibrations pass to the pinion shaft 55, and to the second yoke 70 attached to the pinion shaft 55. However, the resilient members 120 within the U-joint 15 absorb many of the vibrations such that they do not pass to the first yoke 65, the steering shaft 25, or the steering wheel 20. Other sources of undesired vibrations, which can be absorbed by the resilient members 120, include vibrations produced by the engine and power steering system.

As one of ordinary skill will realize, the level of resilience provided by the resilient members 120 can be varied to accommodate different types of vibrations or larger magnitude vibrations. Generally, more resilient members 120 will isolate more vibrations. However, if the resilient members 120 are too resilient, the steering will feel “soft” and the handling of the vehicle may be adversely affected. As such, the amount of vibration isolation provided by the resilient members 120 should be balanced against the effect the resilient members 120 may have on the handling characteristics of the vehicle.

Generally, each of the four trunion ends 95 would be similar to the trunion end 95 illustrated in FIGS. 4 and 5. However, other constructions may employ two trunion ends 95 that include resilient members 120 and two trunion ends that do not. For example, the first trunion 75 and third trunion 85, or the second trunion 80 and fourth trunion 90 could include resilient members while the second trunion 80 and fourth trunion 90, or the first trunion 75 and third trunion 85 do not. Such an arrangement would still provide vibration isolation between the two shafts 25, 55 that are coupled by the U-joint 15.

The placement of the resilient members 120 adjacent the boss 145 allows the inner cap 125 to substantially cover and protect the resilient member 120, while simultaneously defining the inner race 170 for the bearing 135. The only exposed portion of the resilient member 120 is the end. If desired, a face seal (not shown) can be positioned near the exposed end to completely enclose the resilient member 120 and/or to cover the seal 140 and the bearing 135.

In another construction, illustrated in FIG. 6, a resilient member 300 is formed to also function as the face seal. In this construction, the resilient member 300 includes a leg portion or circumferentail flange 305 that extends substantially normal to the inner surface 150. The flange 305 extends radially outward and includes an angled portion 310 that contacts or is positioned close to the outer cylindrical surface 180 (i.e., is disposed radially outside of the outer cup 130 of the bearing 135). Thus, the resilient member 300 itself substantially encloses the space that includes the bearing 135.

The arrangement described herein includes a reduced number of parts compared to prior vibration isolation systems. In addition, the arrangement is simpler than previous arrangements, thereby allowing easier, faster, and more accurate assemblies. By elimination of the extra components of a typical isolation system, the new system is smaller and can better fit into space-restricted applications.

Furthermore, the system described herein can be easily adapted to different applications with slight changes to the resilient member 120 (e.g., thickness, resilience (durometer), rib orientation, rib spacing, rib quantity, etc.). As such, the U-joint 15 is easily adapted to many different applications, only some of which have been described herein.

The U-joint 15 described herein provides many advantages over prior vibration isolation systems such as those used in steering systems. For example, the U-joint 15 reduces axial and radial looseness within the steering linkage. The compression of the resilient member in the radial direction by the bearing and the compression of the resilient member in the axial direction by the inner cap take-up excess clearance and reduce the looseness of the steering linkage. The U-joint 15 occupies less space than typical isolator systems and thus also provides for an increased collapse stroke should a crash occur. In addition, the U-joint 15 allows for additional commonization of parts as each steering system design can employ a U-joint 15 that also performs the function of the prior vibration isolation system. In addition, the U-joint bending effort is reduced due to the low compressive stresses of the resilient member 120.

Thus, the invention provides, among other things, a new and useful U-joint 15. More particularly, the invention provides a new and useful U-joint 15 that provides vibration isolation between two shafts 25, 55 that may or may not be aligned along a common axis.

What is claimed is:

1. A joint operable to couple a first shaft to a second shaft, the joint comprising:
a first yoke coupled to the first shaft and defining a first aperture;
a second yoke coupled to the second shaft and defining a second aperture;
a first bearing coupled to the first yoke and at least partially disposed within the first aperture;
a second bearing coupled to the second yoke and at least partially disposed within the second aperture;
a cross member having a first boss coupled to the first bearing and a second boss coupled to the second bearing;
a first resilient member positioned between the first bearing and the first boss to interconnect the first boss and the first yoke; and
a second resilient member positioned between the second bearing and the second boss to interconnect the second boss and the second yoke.

2. The joint of claim 1, wherein the first yoke includes a first ear that defines the first aperture and a second ear that defines a third aperture, and wherein the second yoke includes a third ear that defines the second aperture and a fourth ear that defines a fourth aperture.

3. The joint of claim 2, further comprising a third bearing coupled to the first yoke and at least partially disposed within the third aperture and a fourth bearing coupled to the second yoke and at least partially disposed within the fourth aperture.

4. The joint of claim 3, wherein the cross member includes a third boss coupled to the third bearing and a fourth boss coupled to the fourth bearing.

5. The joint of claim 4, wherein the first boss and the third boss define a first axis and the second boss and the fourth boss defines a second axis that is substantially normal to the first axis.

6. The joint of claim 4, further comprising a third resilient member positioned between the third bearing and the third boss to interconnect the third boss and the first yoke, and a fourth resilient member positioned between the fourth bearing and the fourth boss to interconnect the fourth boss and the second yoke.

7. The joint of claim 1, wherein the first boss defines a first axis and the second boss defines a second axis, the first axis being substantially normal to the second axis.

8. The joint of claim 1, wherein the first resilient member includes a first outer surface sized to closely engage the first bearing and wherein the second resilient member includes a second outer surface sized to closely engage the second bearing.

9. The joint of claim 8, wherein the first outer surface includes a plurality of ribs and the second outer surface includes a plurality of ribs.

10. The joint of claim 1, wherein the first resilient member includes a first inner surface sized to closely fit over the first boss and wherein the second resilient member includes a second inner surface sized to closely fit over the second boss.

11. The joint of claim 1, wherein at least one of the first resilient member and the second resilient member includes a flange positioned such that a portion of the flange is disposed outside of the respective first bearing and second bearing.

12. A joint operable to couple a first shaft to a second shaft, the joint comprising:
a cross member including a first trunion and a second trunion, the second trunion adapted to couple with the second shaft;
a first resilient member having an inner surface sized to closely fit the first trunion, and an outer surface; and
a first inner cap having a cap inner surface sized to closely fit the outer surface of the first resilient member, and a cap outer surface adapted to couple with the first shaft.

13. The joint of claim 12, wherein the outer surface of the first resilient member includes a plurality of ribs.

14. The joint of claim 12, further comprising a first outer cup at least partially covering the first inner cap, and a rolling element disposed between the first inner cap and the first outer cup.

15. The joint of claim 14, wherein the first resilient member includes a flange formed as part of, and extending from the first resilient member, the flange positioned such that a portion of the flange is disposed outside of the first outer cup.

16. The joint of claim 12, wherein the cross member includes a third trunion disposed opposite the first trunion and a fourth trunion disposed opposite the second trunion.

17. The joint of claim 16, further comprising a second resilient member having a second inner surface sized to closely fit the third trunion, and a second outer surface, and a second inner cap having a second cap inner surface sized to closely fit the second outer surface of the second resilient member, and a second cap outer surface adapted to couple with the first shaft.

18. A joint operable to couple a first shaft to a second shaft, the joint comprising:
a cross member including a first trunion and a second trunion, the second trunion adapted to couple with the second shaft;
a first resilient member at least partially covering the first trunion;
a first inner cap at least partially covering the first resilient member;
a first outer cup at least partially covering the first inner cap and engageable with the first shaft; and
a rolling element disposed between the first inner cap and the first outer cup.

19. The joint of claim 18, further comprising a first flange formed as part of, and extending from the first resilient member, the first flange positioned such that a portion of the first flange is disposed outside of the first outer cup.

20. The joint of claim 18, wherein the first resilient member includes an inner surface sized to closely fit the first trunion and an outer surface including a plurality of ribs, and wherein the first inner cap includes an inner cap surface sized to closely fit the outer surface of the first resilient member.

21. The joint of claim 20, wherein the cross member includes a third trunion disposed opposite the first trunion and a fourth trunion disposed opposite the second trunion, the joint further comprising a second resilient member at least partially covering the third trunion, a second inner cap at least partially covering the second resilient member, a second outer cup at least partially covering the second inner cap and engageable with the first shaft.

22. The joint of claim 21, further comprising a second flange formed as part of, and extending from the second resilient member, the second flange positioned such that a portion of the second flange is disposed outside of the second outer cup.
